(19) United States
(12) Patent Application Publication
(10) Pub. No.: US 2009/0320626 A1
(43) Pub. Date: Dec. 31, 2009

(54) Actuator

(75) Inventors: Jin-Cheng Lin, Taichung City (TW); Hsin-An Chiang, Taichung City (TW)

Correspondence Address: CHARLES E. BAXLEY, ESQUIRE, 90 JOHN STREET, SUITE 309, NEW YORK, NY, 10038, US

(73) Assignee: Hiwin Mikrosystem Corp.

(21) Appl. No.: 12/215,345

(22) Filed: Jun. 26, 2008

(51) Int. Cl. F16H 29/02

(52) U.S. Cl. 74/89.22

(57) ABSTRACT

An actuator comprises a motor that drives a screw to rotate through a pulley mechanism and a reduction mechanism. The actuator is advantageous by easy assembly, easy replacement of the reduction mechanism and easy reconfiguration of the motor and the reduction mechanism.

### BACKGROUND OF THE INVENTION

1. Technical Field

The present invention relates to actuators.

2. Description of Related Art

FIG. 1 depicts a conventional linear actuator, wherein a motor 1 outputs a rotational force through a reduction mechanism 2 to a screw 3 so that the screw 3 rotates and in turn drives a screw holder 4 coupled therewith to shift along a rail 5.

However, the aforementioned conventional actuator has some defects.

First, the motor 1 has a transmission shaft that is configured as being perpendicular to the screw 3 with the reduction mechanism 2 connected therebetween. Therefore, such conventional actuator requires a relatively large installment area, thus being inferior in spacial flexibility.

Besides, the reduction mechanism 2 is substantially a gearbox collocated therein with a plurality gears that have a predetermined gear ratio so as to give an expected reduction ratio. These molded and fixedly collocated gears in the gearbox cannot be re-collocated or replaced for altering the given reduction ratio of the reduction mechanism 2, thus being inferior in mechanical flexibility.

### SUMMARY OF THE INVENTION

One objective of the present invention is to provide an actuator that is adaptable to even a relatively narrow installation area.

Another objective of the present invention is to provide an actuator that is easy to be assembled.

Another objective of the present invention is to provide an actuator whose reduction mechanism is replaceable so as to give different reduction ratios.

Another objective of the present invention is to provide an actuator whose pulleys are easy to be assembled and positioned and serve to belt is automatically tensed as soon as the pulleys are assembled, thereby eliminating additional needs of idler pulleys for tensing the belt.

Another objective of the present invention is to provide an actuator wherein a configuration of its reduction mechanism and motor is convertible.

To achieve these and other objectives of the present invention, the disclosed actuator primarily comprises:

a motor, outputting a rotational force to a pulley mechanism that in turn transfers the rotational force to a reduction mechanism so that the reduction mechanism transfers the rotational force to a screw positioned in an outer cover, wherein the pulley mechanism comprises:

a central shaft coupled with the reduction mechanism and assembled with a driven pulley of a pulley set, in which the driven pulley is settled in a front cover and a belt winds around the driven pulley;

a driving shaft of the motor arranged parallel to the screw and assembled with a driving pulley of the pulley set, in which the driving pulley is settled in the front cover and the belt also winds around the driving pulley so that the belt is tensed as receiving a lateral pulling force, and in which the motor has a housing affixed to the front cover; and

a rear cover, combined with the front cover so as to jointly enclose the pulley set.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a schematic drawing of a conventional actuator;

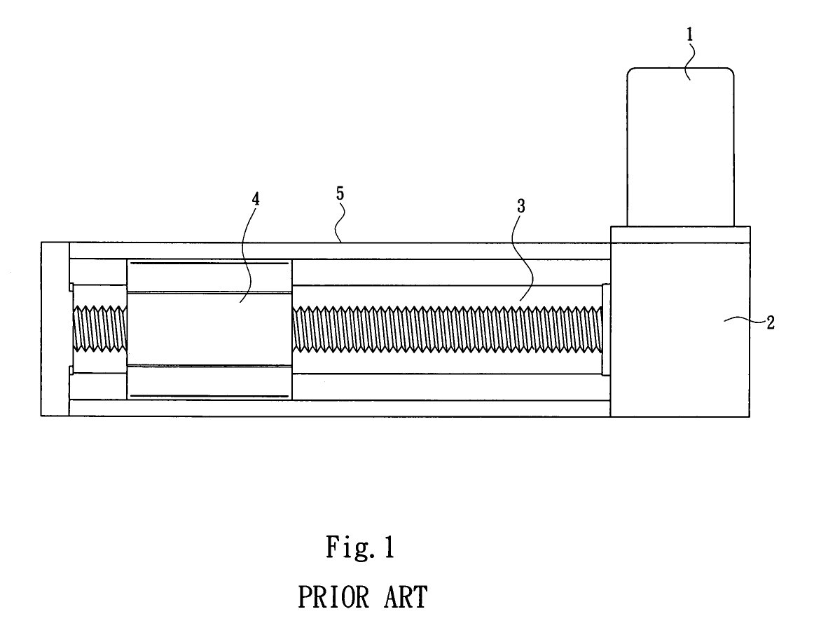

FIG. 2 is a perspective view of an actuator of the present invention;

FIG. 3 is an assembled sectional view of the actuator of the present invention;

FIG. 4 is a disassembled sectional view of the actuator of the present invention;

FIG. 5 provides a first configuration of the actuator of the present invention wherein a motor is settled below a reduction mechanism;

FIG. 6 provides a second configuration of the actuator of the present invention wherein the motor is settled at left of the reduction mechanism;

FIG. 7 provides a third configuration of the actuator of the present invention wherein the motor is settled on the reduction mechanism; and

FIG. 8 provides a fourth configuration of the actuator of the present invention wherein the motor is settled at right of the reduction mechanism.

### DETAILED DESCRIPTION OF THE PREFERRED EMBODIMENT

While a preferred embodiment is provided herein for illustrating the concept of the present invention as described above, it is to be understood that the components in these drawings are made for better explanation and need not to be made in scale.

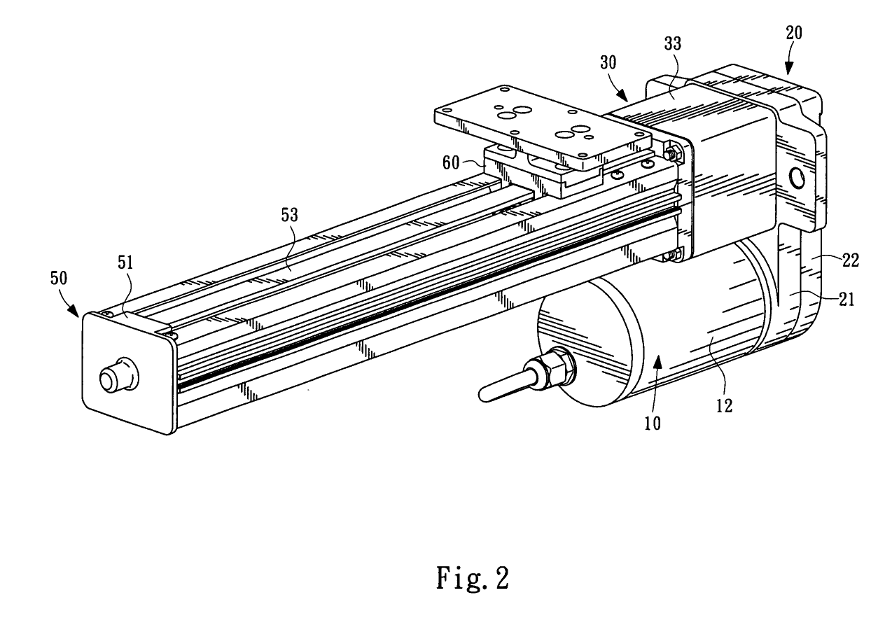

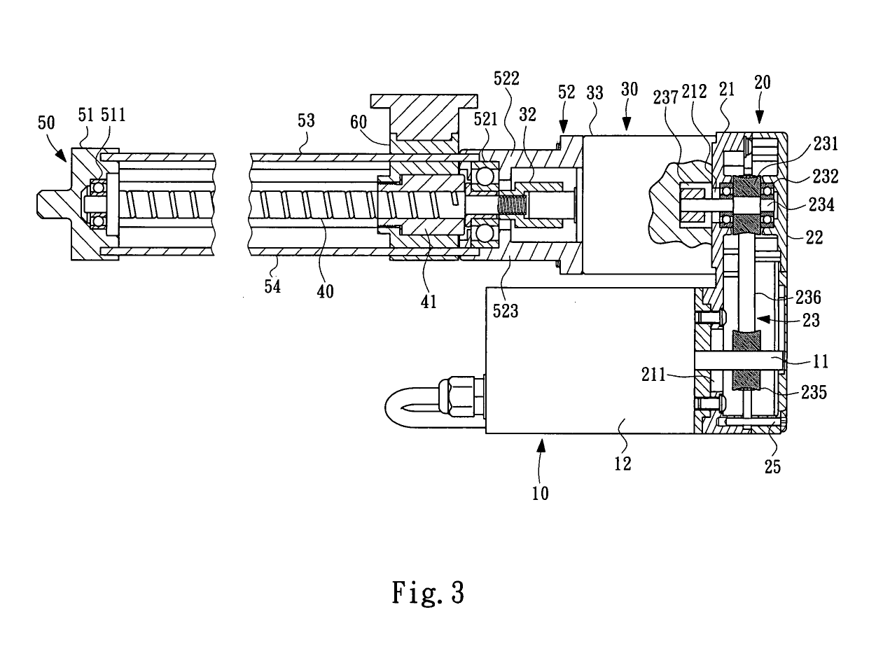

FIG. 2 apparently describes an actuator of the present invention. As can be seen in the drawing, the actuator comprises a motor 10, a pulley mechanism 20, a reduction mechanism 30, a screw 40 (shown in FIG. 3), an outer cover 50, and a shiftable seat 60. The motor 10 outputs a rotational force to the screw 40 through the pulley mechanism 20 and the reduction mechanism 30 so that the screw 40 are driven by the rotational force to shift the shiftable seat 60 along the screw 40.

FIG. 3 is an assembled sectional view of the actuator of the present invention. Accordingly, the outer cover 50 comprises a front positioning-seat 51 and a rear positioning-seat 52 that position two ends of the screw 40. Bearings 511, 521 provided at the two ends of the screw 40 for ensure stable rotation of the screw 40 are settled in the front positioning-seat 51 and a rear positioning-seat 52, respectively. The rear positioning-seat 52 is composed of a first member 522 and a second member 523 that face each other to embrace and position the bearing 521 therebetween. Each of two side plates 53, 54 has two ends inlaid in the front positioning-seat 51 and a rear positioning-seat 52, respectively. A screw seat 41 is mounted on the screw 40 and the shiftable seat 60 is then mounted on the screw seat 41 while side walls of the shiftable seat 60 are passed through by the side plates 53, 54.

As for the reduction mechanism 30, it is substantially a gearbox 33 collocated therein with a plurality gears that have a predetermined gear ratio so as to give an expected reduction ratio. Such reduction mechanism 30 is well known in the art and will not be discussed in great detail herein. The reduction mechanism 30 further has a power-outputting shaft 31 connected with the screw 40 through a coupling 32.

The pulley mechanism 20 includes a front cover 21, a rear cover 22 combined with the front cover 21, and a pulley set 23 deposited between the front cover 21 and the rear cover 22. The front cover 21 is affixed to the gearbox 33 of the reduction mechanism 30. The pulley set 23 includes a driving pulley 235, a driven pulley 231, and a belt 236 connecting the driving pulley 235 and the driven pulley 231 A central shaft 234 rotatably holds a center of the driven pulley 231 and a bearing 232 for ensuring stable rotation of the central shaft 234 is positioned between the front cover 21 and the rear cover 22. The central shaft 234 passes through a hole 212 on the front cover 21 and is further coupled with a gear 237 so as to transfer its rotational force into the reduction mechanism 30. The driving pulley 235 is mounted on a driving shaft 11 of the motor 10 and wound by the belt 236. The motor 12 is affixed to the front cover 21 at a housing 12 thereof. The rear cover 22 is fixedly combined with the front cover 21 by a fastener 25 so that the front and rear covers 21, 22 enclose and hold the pulley set 23.

It can be observed in FIGS. 2 and 3 that the driving shaft 11 of the motor 10 is parallel to the screw 40. The motor 10 is set adjacent to the pulley mechanism 20 so as to allow the actuator to be installed in a relatively narrow area.

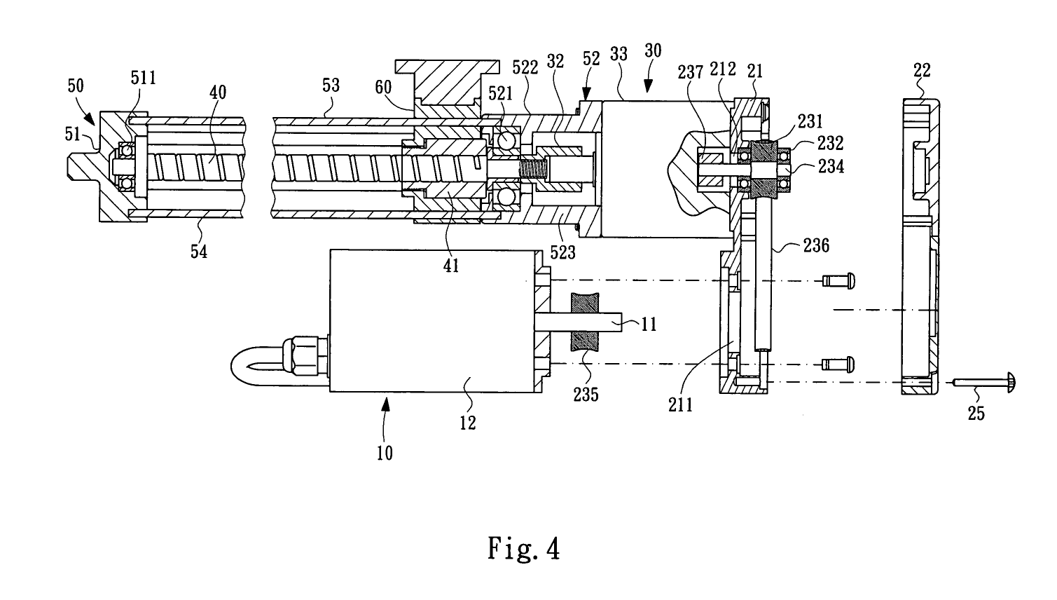

FIG. 4 illustrates how the pulley mechanism 20 is assembled. After mounted with the driven pulley 231, the bearing 232 and the gear 237, the central shaft 234 is received in the front cover 21 and wound by the belt 236. Then the driven shaft 11 is mounted with the driving pulley 235 and received the hole 211 of the front cover 21. After wound around the driving pulley 235, the belt 236 is tensed under a lateral pulling force. At last, the motor 10 is affixed to the front cover 21 and the rear cover 22 is combined with the front cover 21 so that the pulley mechanism 20 is assembled.

Thereby, the pulleys of the disclosed actuator are easy to be assembled and positioned while the belt is automatically tensed around the pulleys as soon as the pulley mechanism 20 is assembled, thereby eliminating additional needs of idler pulleys for tensing the belt. Furthermore, the pulley mechanism 20 can be easily disassembled by reversely conducting the aforementioned steps, thereby allowing a user to replace the reduction mechanism 30 with another one providing a different reduction ratio as the present one provides.

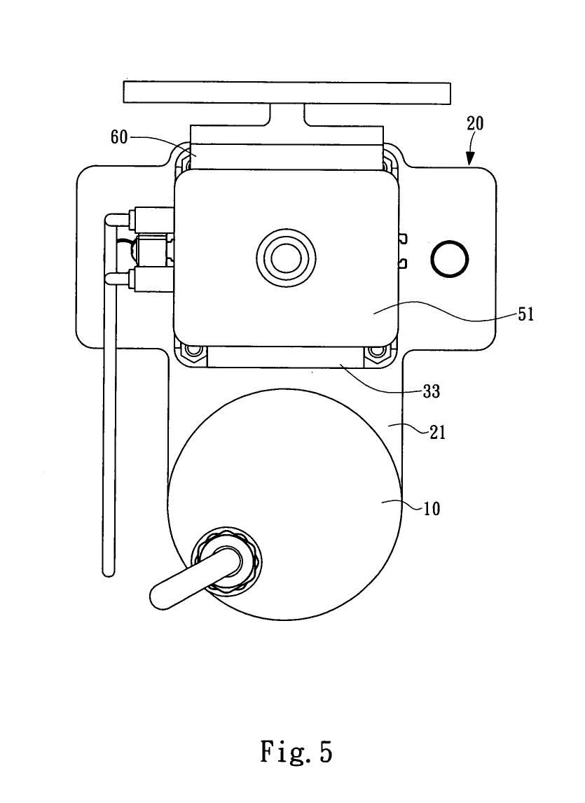

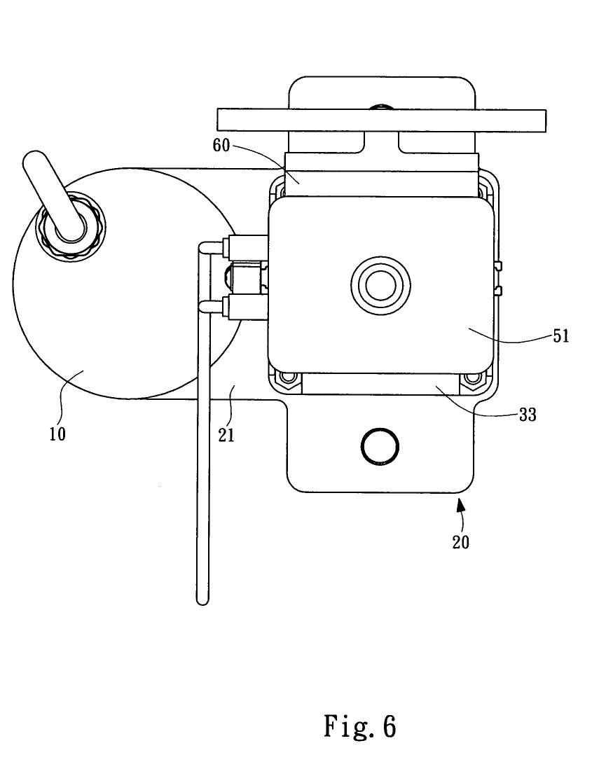

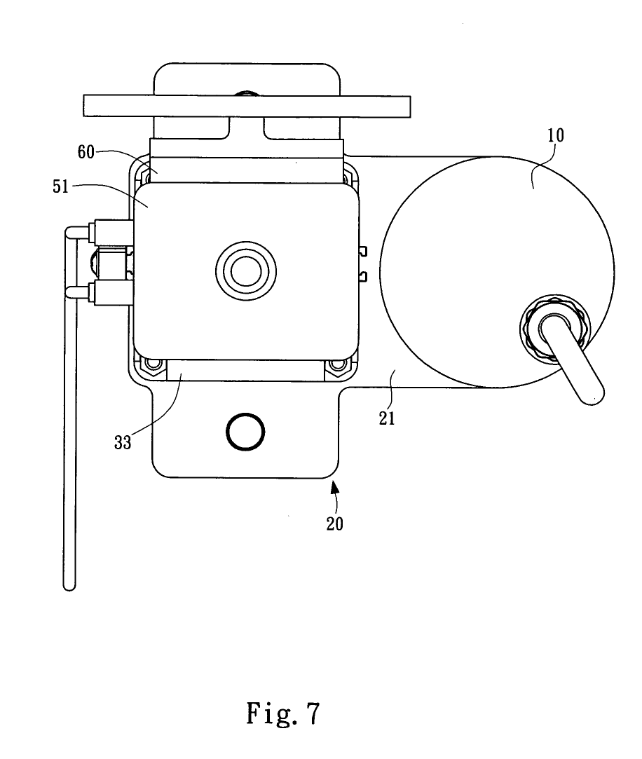

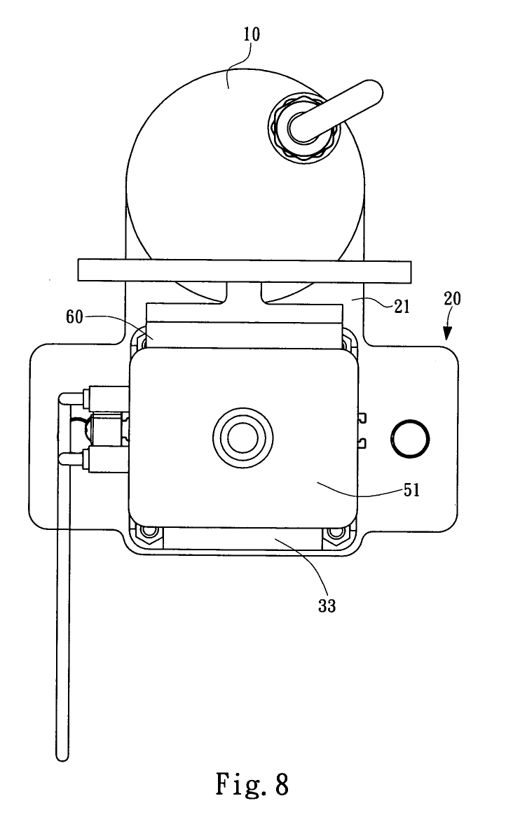

Referring to FIGS. 5 to 8, while the motor 10 is coupled to the reduction mechanism 30 by means of the pulley mechanism 20, by differently orienting the pulley mechanism 20, the motor 10 can be set below or on, or at right or left of the reduction mechanism 30, resulting in enhanced adaptability of the disclosed actuator to satisfy various mechanical arrangements.

Although the particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. An actuator, wherein a motor outputs a rotational force to a pulley mechanism that in turn transfers the rotational force to a reduction mechanism so that the reduction mechanism transfers the rotational force to a screw positioned in an outer cover, the pulley mechanism comprising:
a central shaft coupled with the reduction mechanism and assembled with a driven pulley of a pulley set, in which the driven pulley is settled in a front cover and a belt winds around the driven pulley;
a driving shaft of the motor arranged parallel to the screw and assembled with a driving pulley of the pulley set, in which the driving pulley is settled in the front cover and the belt also winds around the driving pulley so that the belt is tensed as receiving a lateral pulling force, and in which the motor has a housing affixed to the front cover; and
a rear cover, combined with the front cover so as to jointly enclose the pulley set with the front cover.

2. The actuator as claimed in claim 1, wherein, the outer cover comprises a front positioning-seat and a rear positioning-seat in while two ends of the screw and bearings provided at the two ends of the screw are settled, respectively.

3. The actuator as claimed in claim 2, wherein, the rear positioning-seat is composed of a first member and a second member facing each other and combined.

4. The actuator as claimed in claim 2, wherein, at least two side plates are parallel to each other and each of the side plates has two ends inlaid into the front positioning-seat and a rear positioning-seat, respectively.

5. The actuator as claimed in claim 1, wherein, the motor is set below or on, or at left or right of the reduction mechanism.
